(19) United States
(12) Patent Application Publication
(10) Pub. No.: US 2008/0182433 A1
(43) Pub. Date: Jul. 31, 2008

(54) Electrical connector

(75) Inventor: Ted Ju, Keelung (TW)

Correspondence Address: REED SMITH LLP, Suite 1400, 3110 Fairview Park Drive, Falls Church, VA, 22042, US

(73) Assignee: Lotes Co., Ltd.

(21) Appl. No.: 11/882,898

(22) Filed: Aug. 7, 2007

(30) Foreign Application Priority Data
Jan. 26, 2007 (CN) 200720047855.5

(51) Int. Cl. H01R 12/00

(52) U.S. Cl. 439/66

(57) ABSTRACT

An electrical connector is capable of being electrically connected to a first electric component and a second electric component. The electrical connector comprises an insulated body and a plurality of first and second conductive terminals. The insulated body is elastic. The first conductive terminal comprises a base portion, and a first contact portion and a second contact portion respectively extend from two ends of the first base portion. The second conductive terminal comprises a second base portion, and a third contact portion and a fourth conductive portion extend from two ends of the second base portion. Once the first conductive terminal is compressed, the insulated body is forced to deform, and the second contact portion contacts the third contact portion. Furthermore, the second and third contact portions face each other, and tail ends of the second and third contact portions exceed each other and contact each other after compression.

### BACKGROUND OF THE INVENTION

1. Field of the Invention

The invention relates to an electrical connector and, more particularly, to an electrical connector capable of electrically connecting a chip module to a circuit board.

2. Description of the Prior Art

Currently, two methods are generally used to connect a central processing unit (CPU) to a circuit board within a computer. One method is to directly solder the CPU to the circuit board. Although this method was very widely used at early time, it is very difficult to replace, maintain, and upgrade the CPU. Accordingly, this method has been out of date. The other method is to utilize an electrical connector to connect the CPU to the circuit board. This electrical connector generally includes an insulated body and a plurality of conductive terminals accommodated in the insulated body. This method generally requires that the conductive terminals must have high elasticity, but the insulated body almost do not have elasticity. Since the conductive terminals have good elasticity, the electrical conductivity is unavoidably limited and influenced. Once the conductive terminals are compressed, they will elastically deform. Once the conductive terminals are compressed by the CPU and the circuit board for a long time, they always elastically fatigue to influence effective electrical connection between the CPU and the circuit board.

Thus, it is very necessary to design a novelty electrical connector to overcome the aforesaid problems.

### SUMMARY OF THE INVENTION

A scope of the invention is to provide an electrical connector comprising an insulated body with excellent elasticity and a plurality of conductive terminals with good electrical conductivity.

To achieve the aforesaid scope, the electrical connector of the invention, which is capable of being electrically connected to a first electric component and a second electric component, comprises an insulated body and a plurality of first and second conductive terminals. The insulated body is elastic. The first conductive terminal comprises a first base portion, and a first contact portion and a second contact portion respectively extend from two ends of the first base portion. The second conductive terminal comprises a second base portion, and a third contact portion and a fourth conductive portion respectively extend from two ends of the second base portion. Once the first conductive terminal is compressed, the insulated body is forced to deform, and the second contact portion contacts the third contact portion. Furthermore, the second and third contact portions face each other, and tail ends of the second and third contact portions exceed each other and contact each other after compression.

Since the insulated body of the invention has excellent elasticity, and the conductive terminals have good electrical conductivity, the elasticity of the insulated body can enable the conductive terminals to electrically connect the external chip module and the circuit board, so as to facilitate the chip module to be electrically connected to the circuit board.

The advantage and spirit of the invention may be understood by the following recitations together with the appended drawings.

### BRIEF DESCRIPTION OF THE APPENDED DRAWINGS

FIG. 1 is a partial schematic diagram illustrating the electrical connector of the invention connected to the electric components before compression.

FIG. 2 is a partial schematic diagram illustrating the electrical connector as shown in FIG. 1 connected to the electric components after compression.

FIG. 3 is a schematic diagram illustrating the first conductive terminal of the electrical connector as shown in FIG. 1.

FIG. 4 is a schematic diagram illustrating the second conductive terminal of the electrical connector as shown in FIG. 1.

FIG. 5 is a drawing of partial enlargement illustrating the electrical connector as shown in FIG. 1.

FIG. 6 is a drawing of partial enlargement illustrating the electrical connector as shown in FIG. 2.

FIG. 7 is a partial schematic diagram illustrating the conductive terminals of the electrical connector according to a second embodiment of the invention.

FIG. 8 is a partial schematic diagram illustrating the conductive terminals of the electrical connector according to a third embodiment of the invention.

FIG. 9 is a partial schematic diagram illustrating the conductive terminals of the electrical connector according to a fourth embodiment of the invention.

### DETAILED DESCRIPTION OF THE INVENTION

The following embodiments along with the appended drawings are used to describe the electrical connector of the invention.

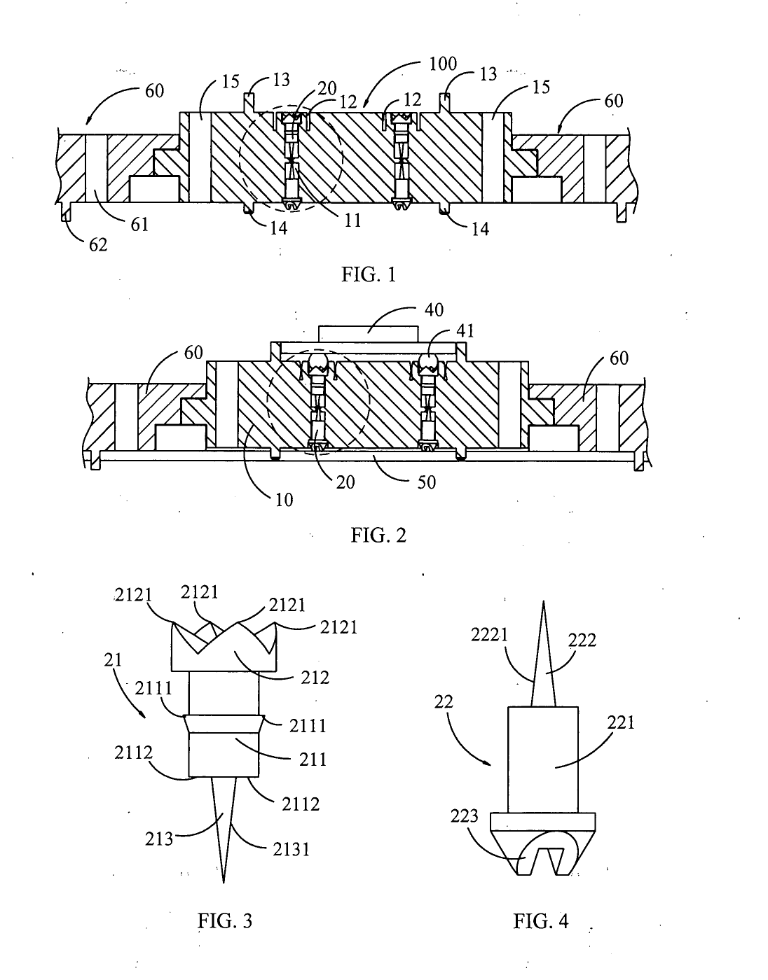

FIGS. 1 and 2 are partial schematic diagrams illustrating the electrical connector 100 of the invention connected to electric components 40, 50 before and after compression. In this embodiment, the first and second electric components 40, 50 are respectively chip module and circuit board, or other components, and the electrical connector 100 is capable of electrically connecting the chip module 40 and the circuit board 50.

As shown in FIGS. 1 and 2, the electrical connector 100 comprises an insulated body 10 and a plurality of conductive terminals 20 (there are only two groups of conductive terminals shown in FIGS. 1 and 2). The insulated body 10 has excellent elasticity and thereon has a plurality of terminal receiving holes 11. At least one part of the conductive terminal 20 is accommodated in the terminal receiving hole 11, and the terminal receiving hole 11 is provided with a protruding portion 111 (shown in FIG. 6) against a second contact portion 213 and a third contact portion 222 of the conductive terminal 20.

Two sides of each terminal receiving hole 11 are respectively provided with a space 12. When the chip module 40 compresses the conductive terminals 20, the insulated body 10 can deform appropriately and the space 12 can accommodate the deformed insulated body 10.

The upper and lower end of the insulated body 10 are respectively provided with two positioning bars 13 and two mounting bars 14 to compactly clamp the chip module 40 and the circuit board 50, and there is a space for accommodating the chip module 40 between two positioning bars 13. The mounting bars 14 are directly held in the mounting holes (not shown in the figure) of the circuit board 50 to fix the insulated body 10 on the circuit board 50. Two ends of the insulated body 10 are provided with positioning holes 15 to fix and position the insulated body 10 on the circuit board 50 through the fixing parts (not shown in the figure, such as bolts or nuts).

Two ends of the electrical connector 100 are provided with a positioning device 60 to fix the electrical connector 100 on the circuit board 50. The positioning device 60 is provided with throughing holes 61 and fixing bars 62 to fix and position the positioning device 61 on the circuit board 50.

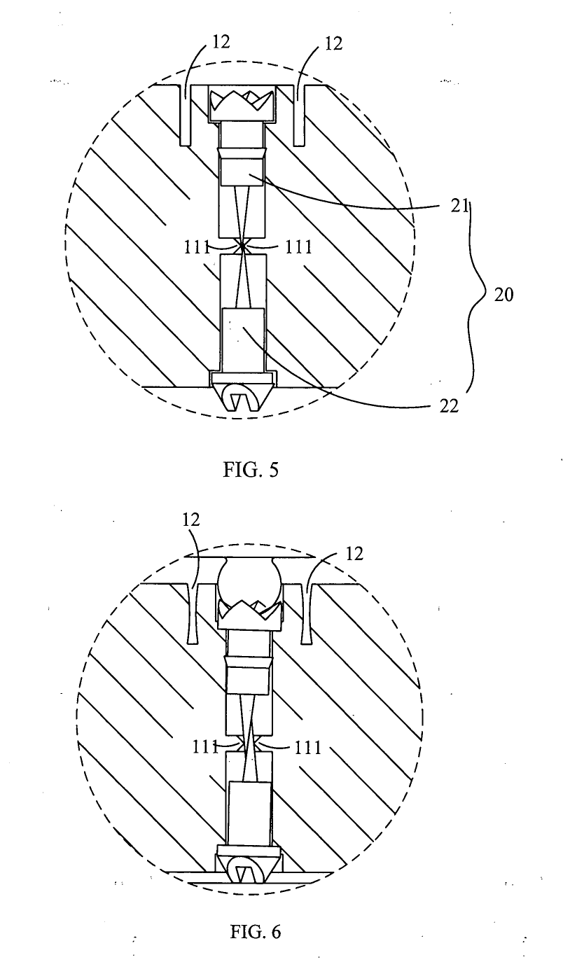

FIGS. 5 and 6 are drawings of partial enlargement illustrating the conductive terminals 20 connected to the first and second electric components 40, 50 before and after compression. The conductive terminals 20 are made of C1100, C1010 or C1020, which can make the conductive terminals 20 keep original shape after compression and have good electrical conductivity.

Each conductive terminal 20 comprises first and second conductive terminals 21, 22, and the first and second conductive terminals 21, 22 are columnar (or sheet-shaped, etc). The first conductive terminal 21 electrically contacts the chip module 40, and the second conductive terminal 22 electrically contacts the circuit board 50, such that the chip module set 40 can be electrically connected to the circuit board 50 through the conductive terminal 20.

FIG. 3 is a schematic diagram illustrating the first conductive terminal 21. The first conductive terminal 21 comprises a first base portion 211, and first and second contact portions 212, 213 respectively extend from two ends of the first base portion 211. Two sides and the lower end of the first base portion 211 are respectively provided with protruding portions 2111 and supports 2112. The protruding portions 2111 are clamped in the terminal receiving holes 11 (shown in FIGS. 5 and 6), so as to prevent the first conductive terminals 20 from moving in the terminal receiving holes 11. The supports 2112 are used to prevent the third contact portion 222 of the second conductive terminal 22 from moving too much and exceeding the first base portion 211 when the first and second conductive terminals 21, 22 are connected. There are contact points 2121 at the end of the first contact portion 212, and each of contact points 2121 contacts tin balls 41 of the chip module 40 to form multi-point contact, which is helpful for electrical connection between the first conductive terminal 21 and the chip module 40. The second contact portion 213 has an incline 2131 (or an arc-shaped surface).

FIG. 4 is a schematic diagram illustrating the first conductive terminal 22. The second conductive terminal 22 comprises a second base portion 221, and a third contact portion 222 and a fourth conductive portion 223 respectively extend from two ends of the second base portion 221. The third contact portion 222 also has an incline 2221 (at least one of the second and third contact portions 213, 222 has an incline, and the incline also can be an arc-shaped surface based on the invention). When the first conductive terminal 21 contacts the second conductive terminal 22 (shown in FIGS. 5 and 6), the second and third contact portions 213, 222 oppositely move to increase the contact force between the incline of the first and second conductive terminals 21, 22 (if obliquity is radian, the incline is an arc-shaped surface) and the other contact portions. The second and third contact portions 213, 222 face each other, and tail ends of the second and third contact portions exceed each other and contact each other after compression. The fourth conductive portion 222 is electrically connected to the circuit board 50 by soldering.

Before assembling, the electrical connector 100 is fixed on the circuit board 50 first, and then the chip module 40 is fixed on the electrical connector 100, so that the chip module 40 compresses the first conductive terminal 21, as shown in FIGS. 1 to 4. The conductive terminals 20 have good electrical conductivity and keep original shape after compression without elastically deforming. Since the insulated body 10 is elastic, the insulated body 10 can elastically deform and be pressed transversally, so as to result in appropriately deformed longitudinal length and shortened transversal length of the insulated body 10. The insulated body 10 is provided with a space 12, which also elastically deforms with elastic deformation of the insulated body 10 to accommodate the elastically deformed insulated body 10. In other words, the inner wall of the space 12 is changed to arc-shaped (shown in FIGS. 3 and 4). The first and second conductive terminals 21, 22 appropriately move to each other when the longitudinal length of the insulated body 10 is shortened, so that the tail ends of the second and third contact portions 213, 222 exceed each other (shown in FIGS. 3 and 4) and contact each other after compression, so as to increase the contact force between the incline (if obliquity is radian, the incline is an arc-shaped surface) of the first and second conductive terminals 21, 22 and the other contact portions and then electrically connect the chip module 40 to the circuit board 50. When the chip module 40 is taken away from the electrical connector 100, the original shape of the insulated body 10 is recovered and the tail ends of the second and third contact portions 213, 222 will not exceed each other correspondingly (shown in FIGS. 1 and 3).

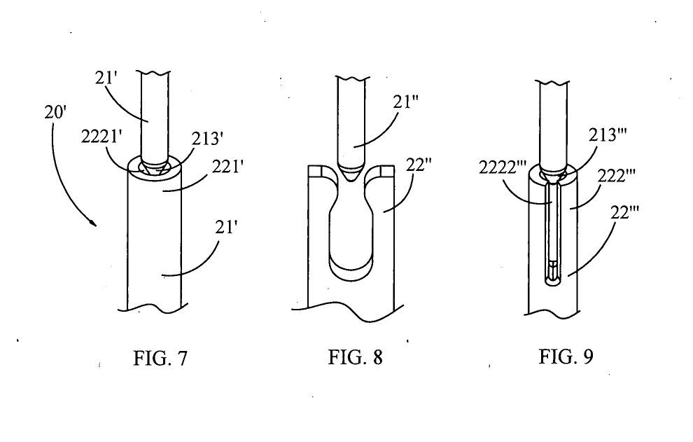

FIG. 7 is a partial schematic diagram illustrating the conductive terminals of the electrical connector according to a second embodiment of the invention. In this embodiment, the conductive terminal 20′ also comprises a first conductive terminal 21′ and a second conductive terminal 22′. The first and second conductive terminals 21′, 22′ are columnar and a concave 2221′ is formed on the center of the third contact portion 222′ of the second conductive terminal 22′ to accommodate the second contact portion 213′ of the first conductive terminal 21′, or a concave formed on the center of the second contact portion 213′ of the first conductive terminal 21′ to accommodate the third contact portion 222′ of the second conductive terminals 22′.

FIG. 8 is a partial schematic diagram illustrating the conductive terminals of the electrical connector according to a third embodiment of the invention. The difference between the third and second embodiments is that the second conductive terminal 22″ is sheet-shaped and the first conductive terminal 21″ is columnar. The structure and principle of the third embodiment are the same as the second embodiment, and the related description is not mentioned again here.

FIG. 9 is a partial schematic diagram illustrating the conductive terminals of the electrical connector according to a fourth embodiment of the invention. The difference between the fourth and second embodiments is that one side of the third contact portion 222′″ of the second conductive terminals 22′″ is provided with an opening 2222′″, such that the second contact portion 213′″ accommodated in the third contact portion 222′″ can be saw via the opening 2222′″. The structure and principle of the fourth embodiment are the same as the second embodiment, and the related description is not mentioned again here.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electrical connector capable of being electrically connected to a first electric component and a second electric component, the electrical connector comprising an insulated body and a plurality of conductive terminals, the insulated body thereon having a plurality of terminal receiving holes, at least one part of the conductive terminal being accommodated in the terminal receiving hole, the electrical connector being characterized in that: the insulated body is elastic, each of the conductive terminals comprises a first conductive terminal and a second conductive terminal, the first conductive terminal comprises a first base portion, a first contact portion and a second contact portion respectively extend from two ends of the first base portion, the second conductive terminal comprises a second base portion, a third contact portion and a fourth conductive portion respectively extend from two ends of the second base portion, once the first conductive terminal is compressed, the insulated body is forced to deform, and the second contact portion contacts the third contact portion.

2. The electrical connector of claim 1 characterized in that: at least one of the second and third contact portions has an incline, and a contact force between the incline and the other contact portion increases while the second contact portion moves with respect to the third contact portion.

3. The electrical connector of claim 1 characterized in that: at least one of the second and third contact portions has an arc-shaped surface, and a contact force between the arc-shaped surface and the other contact portion increases while the second contact surface moves with respect to the third contact portion.

4. The electrical connector of claim 1 characterized in that: the conductive terminal further comprises a support for preventing the contact portions of the first and second conductive terminals from exceeding the base portions mutually.

5. The electrical connector of claim 1 characterized in that: at least one side of the conductive terminal thereon has a protruding portion.

6. The electrical connector of claim 1 characterized in that: the center of one of the second and third contact portions is concave for accommodating the other contact portion.

7. The electrical connector of claim 1 characterized in that: the first and second conductive terminals are sheet-shaped.

8. The electrical connector of claim 1 characterized in that: the fourth conductive portion is electrically connected to the second electric component by soldering.

9. The electrical connector of claim 1 characterized in that: the contact portion between the conductive terminal and the electric component has at least two contact points.

10. The electrical connector of claim 1 characterized in that: the insulated body has a space for accommodating the deformed insulated body.

11. The electrical connector of claim 1 characterized in that: the terminal receiving hole of the insulated body therein has a protruding portion capable of clamping the conductive terminal, so as to enable the first conductive terminal to contact the second conductive terminal compactly.

12. The electrical connector of claim 1 characterized in that: the conductive terminal is capable of keeping original shape after compression.

13. An electrical connector capable of being electrically connected to a first electric component and a second electric component, the electrical connector comprises an insulated body and a plurality of conductive terminals, the insulated body thereon having a plurality of terminal receiving holes, at least one part of the conductive terminal being accommodated in the terminal receiving holes, the electrical connector being characterized in that: the insulated body is elastic, each of the conductive terminals comprises a first conductive terminal and a second conductive terminal, the first conductive terminal comprises a first base portion, a first contact portion and a second contact portion respectively protrude from two ends of the first base portion, the second conductive terminal comprises a second base portion, a third contact portion and a fourth conductive portion respectively protrude from two ends of the second base portion, the second and third contact portions face each other, and tail ends of the second and third contact portions exceed each other and contact each other after compression.

14. The electrical connector of claim 13 characterized in that: at least one of the second and third contact portions has an incline, and a contact force between the incline and the other contact portion increases while the second contact portion moves with respect to the third contact portion.

15. The electrical connector of claim 13 characterized in that: at least one of the second and third contact portions has an arc-shaped surface, and a contact force between the arc-shaped surface and the other contact portion increases while the second contact surface moves with respect to the third contact portion.

16. The electrical connector of claim 13 characterized in that: the conductive terminal is capable of keeping original shape after compression.

17. The electrical connector of claim 13 characterized in that: the first and second conductive terminals are sheet-shaped.

18. The electrical connector of claim 13 characterized in that: the contact portion between the conductive terminal and the electric component has at least two contact points.

19. The electrical connector of claim 13 characterized in that: the insulated body has a space for accommodating the deformed insulated body.

20. The electrical connector of claim 13 characterized in that: the terminal receiving hole of the insulated body therein has a protruding portion capable of clamping the conductive terminal, so as to enable the first conductive terminal to contact the second conductive terminal compactly.
